(19) United States
(12) Patent Application Publication
(10) Pub. No.: US 2026/0365804 A1
(43) Pub. Date: Nov. 19, 2026

(54) POLYIMIDE FILM WITH EXCELLENT HEAT RESISTANCE AND MECHANICAL PROPERTY AND METHOD FOR PREPARING SAME

(71) Applicant: PI Advanced Materials Co., Ltd., Chungcheongbuk-Do (KR)

(72) Inventors: Dong Young Kim, Chungcheongbuk-Do (KR); Sung Yul Back, Chungcheongbuk-Do (KR); Dong Young Won, Chungcheongbuk-Do (KR)

(21) Appl. No.: 19/514,971

(22) PCT Filed: Aug. 22, 2024
(86) PCT No.: PCT/KR2024/012537

§ 371 Date: Feb. 27, 2026

(30) Foreign Application Priority Data
Aug. 31, 2023 (KR) 10-2023-0115590

(51) Int. Cl. C08J 5/18; C08G 73/10

(52) U.S. Cl. CPC C08J 5/18; C08G 73/1028; C08G 73/1042; C08G 73/1071; C08J 2379/08

(57) ABSTRACT

Provided is a polyimide film comprising: a copolymer in which a dianhydride including monomer pyromellitic dianhydride (PMDA) is copolymerized with a diamine monomer including 4,4′-diaminodiphenyl ether (ODA) and m-tolidine (m-TD), wherein the film has a coefficient of thermal expansion in a transverse direction (TD) (CTE_{TD}) of −5 to 2.5 ppm/°C measured at a temperature range of 50 to 200 °C and a heating rate of 10 °C/min, and a modulus of 8 GPa or more.

### TECHNICAL FIELD

The present disclosure relates to a polyimide film with excellent heat resistance and mechanical property and a method for preparing the same. Specifically, the present disclosure relates to a polyimide film with excellent heat resistance and mechanical property without using p-phenylenediamine (PPD), and a method for preparing the same.

### BACKGROUND ART

Polyimide (PI) is a polymer material based on an imide ring having excellent chemical stability together with a rigid aromatic main chain, which has the highest level of heat resistance, chemical resistance, electrical insulation, chemical resistance, and weather resistance among organic materials.

In general, polyimide (PI) film is a film made from polyimide resin, wherein the polyimide resin refers to a highly heat-resistant resin obtained by performing solution polymerization on aromatic dianhydride and aromatic diamine or aromatic diisocyanate to prepare a polyamic acid derivative, followed by ring-closure dehydration at high temperature and imidization.

Conventional polyimide resins mainly employ p-phenylenediamine (PPD) as an aromatic diamine, but PPD causes bubbling and gel formation during film preparation, resulting in low productivity and process efficiency. In addition, when low coefficient of thermal expansion is required, there are issues such as poor chemical resistance despite the use of large amounts of PPD.

Therefore, there is a need to develop a polyimide film with excellent heat resistance and mechanical property after imidization even without using p-phenylenediamine.

### DISCLOSURE

### Technical Problem

An object of the present disclosure is to provide a polyimide film with excellent heat resistance and mechanical property after imidization without using p-phenylenediamine (PPD), and a method for preparing the same.

In addition, another object of the present disclosure is to provide a display device comprising the polyimide film.

### Technical Solution

Various modifications can be made and various embodiments may be implemented in the present disclosure, and specific embodiments are illustrated in the drawings and described in detail. However, these embodiments are not intended to limit the present disclosure to specific embodiments, and should be understood to comprise all modifications, equivalents, and substitutes included in the spirit and scope of the present disclosure.

Terms used in the present application are only used to describe specific embodiments and are not intended to limit the present disclosure. Singular expressions include plural expressions unless the context clearly indicates otherwise. In the present specification, terms such as “comprise” or “have” are intended to designate the presence of features, numbers, steps, operations, components, parts, or combinations thereof described in the specification and it should not be understood as precluding the possibility of the presence or addition of one or more other features, numbers, steps, operations, components, parts, or combinations thereof.

When amounts, concentrations, or other values or parameters herein are given as ranges, preferred ranges, or lists of upper desirable values and lower desirable values, it should be understood as specifically disclosing all ranges formed by any pair of any upper range limit or preferred value and any lower range limit or preferred value, regardless of whether the scope is separately disclosed.

Where ranges of numerical values are stated herein, unless otherwise stated, it is intended that the endpoints of the range and the scope of the parent invention within the range are not limited to the specific values stated when defining the range.

As used herein, “dianhydride” is intended to include precursors or derivatives thereof, which are also referred to as “dianhydride” or “acid dianhydride”. These products may technically not be dianhydrides, but will nonetheless react with diamines to form polyamic acids, and the polyamic acids may be converted back into polyimides.

As used herein, “diamine” is intended to include precursors or derivatives thereof, which may technically not be diamines, but will nonetheless react with dianhydride acid to form a polyamic acid, and the polyamic acid may be converted back into polyimide.

Further, unless defined otherwise, all terms used herein, including technical or scientific terms, have the same meaning as commonly understood by one of ordinary skill in the art to which the present disclosure belongs. Terms such as those defined in commonly used dictionaries should be interpreted as having a meaning consistent with the meaning in the context of the related art, and unless explicitly defined in the present application, it is not to be construed in an idealized or overly formal sense. Specific details for the implementation of the invention will be described below.

The present disclosure relates to a polyimide film with excellent heat resistance and mechanical property and a method for preparing the same.

### Polyimide Film

The present disclosure provides a polyimide film comprising a copolymer in which a dianhydride monomer including pyromellitic dianhydride (PMDA) is copolymerized with a diamine monomer including 4,4′-diaminodiphenyl ether (ODA) and m-tolidine (m-TD), wherein the film has a coefficient of thermal expansion in a transverse direction (TD) (CTE_{TD}) of −5 to 2.5 ppm/° °C measured at a temperature range of 50 to 200 °C and a heating rate of 10 °C/min, and a modulus of 8 GPa or more.

Specifically, the polyimide film may have a coefficient of thermal expansion in a transverse direction (TD) (CTE_{TD}) of −5 to 2.5 ppm/° °C, preferably, −4.5 to 1.5 ppm/° °C, measured at a temperature range of 50 to 200 °C and a heating rate of 10 °C/min.

In detail, the polyimide film may have a modulus of 8 GPa or more. For example, the lower limit of the modulus may be 9 GPa or more, 9.5 GPa or more, or 10 GPa or more. In addition, the upper limit of the modulus is not particularly limited, but may be 18 GPa or less, 17 GPa or less, 16 GPa or less, or 15 GPa or less. The modulus may be determined by preparing samples of 80 mm in length and 15 mm in width, measuring the modulus of the samples at a rate of 20 mm/min using an Instron 5564 UTM machine from INSTRON, and calculating the average of 10 samples.

In the polyimide film, a difference value (CTE_{MD}−CTE_{TD}) between a coefficient of thermal expansion in a machine direction (MD) (CTE_{MD}) and the coefficient of thermal expansion in a transverse direction (TD) (CTE_{TD}) may be −3 to 3 ppm/° °C, preferably −2 to 2 ppm/°C, and more preferably −1.8 to 1.8 ppm/°C.

An average coefficient of thermal expansion (CTE_{Ave}) Of the polyimide film may be −4.25 to 3.0 ppm/°C, and preferably, −4.35 to 2.0 ppm/° °C. The average coefficient of thermal expansion (CTE_{Ave}) may be an average value of the coefficient of thermal expansion in a machine direction (MD) (CTE_{MD}) and the coefficient of thermal expansion in a transverse direction (TD) (CTE_{TD}) of the polyimide film.

The coefficient of thermal expansion in a machine direction (MD) (CTE_{MD}) and the coefficient of thermal expansion in a transverse direction (TD) (CTE_{TD}) may be determined, respectively, by measuring the slope at 10 °C/min 50 mN in the range of 50 to 200 °C using a TA TMA instrument (Q400).

The polyimide film may have a glass transition temperature (Tg) of 380 °C or higher. For example, the lower limit of the glass transition temperature may be 385 °C or higher, 395 °C or higher, or 398 °C or higher. In addition, the upper limit of the glass transition temperature is not particularly limited, but may be 500 °C or lower, 495 °C or lower, or 490 °C or lower. The glass transition temperature is measured at 10 °C/min using DMA.

The polyimide film may have a thickness-based chemical resistance of −25 to −13%, preferably −24.5 to −13.5%.

In one embodiment, the polyimide film may have a weight-based chemical resistance of −25 to −10%, preferably −23.5 to −11%.

The thickness-based chemical resistance above and the weight-based chemical resistance above are measured according to the ASTM D570 absorption rate, respectively. Regarding the impregnation in solution and storage criteria, the chemical resistance is measured by checking the weight and thickness change amounts after impregnation in 15% NaOH solution and storage for 30 minutes under 60 °C conditions.

The polyimide film may have a coefficient of hygroscopic expansion (CHE) of 3 to 6 ppm/RH %, preferably 3.5 to 5 ppm/RH %. The coefficient of hygroscopic expansion may be measured with PMIC equipment by stabilization until no dimensional change occurs, under humidity conditions ranging from 3% to 90% RH.

A thickness of the polyimide film may be appropriately selected in consideration of the use of the polyimide film, the use environment, physical properties thereof, and the like. For example, the polyimide film may have a thickness of 1 to 100 μm, 15 to 70 μm, 25 to 50 μm, or 30 to 45 μm, but is not limited thereto.

Another embodiment of the present disclosure provides a multilayer film comprising the polyimide film and a thermoplastic resin layer.

Another embodiment of the present disclosure provides a flexible metal foil laminate comprising the polyimide film and an electrically conductive metal foil.

Still another embodiment of the present disclosure provides an electronic component comprising the flexible metal foil laminate.

Another embodiment of the present disclosure provides a display device comprising the polyimide film.

### Copolymer

The above copolymer is obtained by copolymerization of a dianhydride monomer including pyromellitic dianhydride (PMDA) and a diamine monomer including 4,4′-diaminodiphenyl ether (ODA) and m-tolidine (m-TD).

The copolymer may be a block copolymer having two or more blocks.

The block copolymer may comprise a first block in which a dianhydride monomer including pyromellitic dianhydride (PMDA) is copolymerized with a diamine monomer including m-tolidine (m-TD); and a second block in which a dianhydride monomer including pyromellitic dianhydride (PMDA) is copolymerized with a diamine monomer including 4,4′-diaminodiphenyl ether (ODA).

The m-tolidine (m-TD) in the total diamine monomers of the copolymer may have an amount of 40 to 80 mol %, preferably 45 to 75 mol %, more preferably 50 to 70 mol %, and even more preferably 55 to 65 mol %. When the amount of the m-tolidine is less than 40 mol %, it is not desirable since the polyimide film has poor low moisture absorption and low dielectric properties and excessively low chemical resistance. When it exceeds 80 mol %, it is not desirable since it is difficult to form a polyimide film thereafter.

The 4,4′-diaminodiphenylether (ODA) in the total diamine monomers of the copolymer may have an amount of 20 to 60 mol %, preferably 25 to 55 mol %, more preferably 30 to 50 mol %, and even more preferably 35 to 45 mol %. When the amount of the 4,4′-diaminodiphenyl ether is less than 20 mol %, it is not desirable since it is difficult to form a polyimide film thereafter. When it exceeds 60 mol %, it is not desirable since the low moisture absorption and low dielectric properties caused by including m-tolidine are insignificant.

A molar ratio of the dianhydride monomer and the diamine monomer may be 1:2 to 2:1, and preferably 1:1.

The copolymer may comprise the diamine monomer in an amount of 90 to 110 mol %, preferably 95 to 105 mol %, more preferably 98 to 102 mol %, and even more preferably 99 to 101 mol %.

The copolymer may comprise the dianhydride monomer in an amount of 90 to 110 mol %, preferably 95 to 105 mol %, more preferably 98 to 102 mol %, and even more preferably 100 mol %.

The copolymer may comprise 95 to 105 mol % of the dianhydride monomer based on 100 mol % of diamine monomer. For example, the lower limit of the dianhydride monomer may be 95.5 mol % or more, 96 mol % or more, 96.5 mol % or more, 97 mol % or more, 97.5 mol % or more, 98 mol % or more, 98.5 mol % or more, 99 mol % or more, or 99.5 mol % or more, and the upper limit thereof may be 105 mol % or less, 104 mol % or less, 103 mol % or less, 102 mol % or less, 101 mol % or less, or 100 mol % or less.

### Method for Preparing Polyimide Film

The present disclosure provides a method for preparing a polyimide film, comprising: copolymerizing a dianhydride monomer including pyromellitic dianhydride (PMDA) with a diamine monomer including 4,4′-diaminodiphenyl ether (ODA) and m-tolidine (m-TD), wherein the polyimide film has a coefficient of thermal expansion in a transverse direction (TD) (CTE_{TD}) of −5 to 2.5 ppm/° °C measured at a temperature range of 50 to 200 °C and a heating rate of 10 °C/min, and a modulus of the polyimide film is 8 GPa or more.

Specifically, the polyimide film may have a coefficient of thermal expansion in a transverse direction (TD) (CTE_{TD}) of −5 to 2.5 ppm/° °C, preferably, −4.5 to 1.5 ppm/° °C, measured at a temperature range of 50 to 200 °C and a heating rate of 10 °C/min.

In detail, the polyimide film may have a modulus of 8 GPa or more. For example, the lower limit of the modulus may be 9 GPa or more, 9.5 GPa or more, or 10 GPa or more. In addition, the upper limit of the modulus is not particularly limited, but may be 18 GPa or less, 17 GPa or less, 16 GPa or less, or 15 GPa or less. The modulus may be determined by preparing samples of 80 mm in length and 15 mm in width, measuring the modulus of the samples at a rate of 20 mm/min using an Instron 5564 UTM machine from INSTRON, and calculating the average of 10 samples.

The copolymerizing may comprise preparing a first block by copolymerizing a dianhydride monomer including pyromellitic dianhydride (PMDA) with a diamine monomer including m-tolidine (m-TD); and preparing a second block by copolymerizing a dianhydride monomer including pyromellitic dianhydride (PMDA) with a diamine monomer including 4,4′-diaminodiphenyl ether (ODA).

In the preparing the first block, an amount of the diamine monomer including the m-tolidine (m-TD) may be greater than an amount of the dianhydride monomer including the pyromellitic dianhydride (PMDA).

Specifically, in the preparing the first block, the amount of the diamine monomer including the m-tolidine (m-TD) may be 40 to 80 mol %, the amount of the dianhydride monomer including the pyromellitic dianhydride (PMDA) may be 20 to 70 mol %, and a ratio (M_{m-TD}/M_{1st PMDA}) of the amount of the diamine monomer including the m-tolidine (m-TD) (M_{m-TD}) to the amount of dianhydride monomer including the pyromellitic dianhydride (PMDA) (M_{1st PMDA}) may be more than 1 and less than 2.

When the ratio (M_{m-TD}/M_{1st PMDA}) is 1 or less or 2 or more, it is not desirable since it is difficult to form a block copolymer with the desired form.

In the preparing the second block, an amount of the diamine monomer including the 4,4′-diaminodiphenyl ether (ODA) may be less than an amount of the dianhydride monomer including the pyromellitic dianhydride (PMDA).

Specifically, in the preparing the second block, the amount of the diamine monomer including the 4, 4′-diaminodiphenyl ether (ODA) may be 20 to 60 mol %, the amount of the dianhydride monomer including the pyromellitic dianhydride (PMDA) may be 30 to 80 mol %, and a ratio (M_{ODA}/M_{2nd PMDA}) of the amount of the diamine monomer including the 4,4′-diaminodiphenyl ether (ODA) (M_{ODA}) to the amount of the dianhydride monomer including the pyromellitic dianhydride (PMDA) (M_{2nd PMDA}) may be more than 0 and less than 1.

When the ratio (M_{ODA}/M_{2nd PMDA}) is equal to 0 or is 1 or more, it is not desirable since it is difficult to form a block copolymer with the desired form.

Each of the first block and the second block may be prepared in the presence of a solvent.

The solvent may comprise at least one selected from the group consisting of N,N′-dimethylacetamide (DMAc), N-methyl-2-pyrrolidone (NMP), N,N′-dimethylformamide (DMF), dimethyl sulfoxide (DMSO), diethyl acetamide (DEAc), N-ethyl-2-pyrrolidone (NEP), N,N′-diethylformamide (DEF), dimethylpropanamide (DMPA), and gamma-butyrolactone (GBL), and preferably N,N′-dimethylformamide (DMF).

Another embodiment of the present disclosure provides a multilayer film comprising the polyimide film prepared by the method for preparing a polyimide film as described above, and a thermoplastic resin layer.

Still another embodiment of the present disclosure provides a flexible metal foil laminate comprising the polyimide film prepared by the method for preparing a polyimide film as described above, and an electrically conductive metal foil.

Still another embodiment of the present disclosure provides an electronic component comprising the flexible metal foil laminate as described above.

Still another embodiment of the present disclosure provides a display device comprising the polyimide film as described above.

### Advantageous Effects

The polyimide film according to the present disclosure and a method for preparing the same do not use p-phenylenediamine (PPD), and thus have the effect of being relatively cost-competitive and having excellent productivity and process efficiency.

In addition, the polyimide film according to the present disclosure has excellent heat resistance and mechanical property.

Further, the polyimide film according to the present disclosure can be applied to display devices.

### BEST MODE

The following exemplary embodiments are presented to help understanding of the present disclosure. The following Examples are only provided to more easily understand the present disclosure, but the content of the present disclosure is not limited by these Examples.

### EXAMPLE

### Example 1. Preparation of Polyimide Film

### Example 1-1

A solution containing a first block (m-TD/PMDA block) was prepared by mixing and polymerizing 80 mol % of a diamine monomer, m-tolidine (m-TD) with 60 mol % of a dianhydride monomer, pyromellitic dianhydride (PMDA), in 100 mol % of dimethylformamide (DMF).

To the solution prepared above, 20 mol % of 4,4′-diaminodiphenylether (ODA) as a diamine monomer and 37 mol % of pyromellitic dianhydride (PMDA) as a dianhydride monomer were mixed and polymerized to form a second block (ODA/PMDA block).

Finally, a polyamic acid including the first block (m-TD/PMDA block) and the second block (ODA/PMDA block) was prepared by further adding 3 mol % of PMDA.

After combining and mixing the polyamic acid with the catalyst, the defoamed polyamic acid was applied to a glass plate. Next, the applied polyamic acid was pushed according to the calculated ratio of solvent and solid with an applicator to evenly distribute the surface. The resulting product was then cured under a nitrogen atmosphere at 130 °C (4 min)→280 °C (4 min)→420 °C (4 min) to obtain a polyimide film. Here, a thickness of the film was prepared to be 33.5 μm.

### Examples 1-2 to 1-6

Each polyimide film was prepared in the same manner as in Example 1-1, except that the amount ratios of m-tolidine, ODA, and PMDA were adjusted as shown in Table 1 below.

### Comparative Example 1-1

A polyimide film was prepared in the same manner as in Example 1-1, except that the amount ratio of m-tolidine, ODA, and PMDA was adjusted as shown in Table 1 below.

### Comparative Example 1-2

A random-copolymerized polyimide film was prepared by mixing 50 mol % of m-tolidine (m-TD) and 50 mol % of 4,4′-diaminodiphenyl ether (ODA) with 97 mol % of the dianhydride compound, pyromellitic dianhydride (PMDA) in 100 mol % of dimethylformamide (DMF), and then further adding 3 mol % of PMDA as a final step.

Table 1 below shows the compositions and amounts of the dianhydride monomers and diamine monomers used in preparing the polyimide films according to Examples 1-1 to 1-6 and Comparative Example 1-1.

TABLE 1

| | | Primary | | Secondary | Tertiary | |
|---|---|---|---|---|---|---|
| | m-TD | PMDA | ODA | PMDA | PMDA | Type of |
| | (mol %) | (mol %) | (mol %) | (mol %) | (mol %) | copolymer |
| Exam- | 80 | 60 | 20 | 37 | 3 | Block |
| ple 1-1 | | | | | | |
| Exam- | 70 | 52.5 | 30 | 44.5 | 3 | Block |
| ple 1-2 | | | | | | |
| Exam- | 60 | 45.0 | 40 | 52.0 | 3 | Block |
| ple 1-3 | | | | | | |
| Exam- | 65 | 48.8 | 35 | 48.2 | 3 | Block |
| ple 1-4 | | | | | | |
| Exam- | 50 | 37.5 | 50 | 59.5 | 3 | Block |
| ple 1-5 | | | | | | |
| Exam- | 40 | 30.0 | 60 | 67.0 | 3 | Block |
| ple 1-6 | | | | | | |
| Compar- | 30 | 22.5 | 70 | 74.5 | 3 | Block |
| ative | | | | | | |
| Exam- | | | | | | |
| ple 1-1 | | | | | | |

Table 2 below shows the composition and amount of the dianhydride monomer and diamine monomer used in preparing the polyimide film according to Comparative Example 1-2.

TABLE 2

| | | | Primary | Secondary | |
|---|---|---|---|---|---|
| | m-TD | ODA | PMDA | PMDA | Type of |
| | (mol %) | (mol %) | (mol %) | (mol %) | copolymer |
| Comparative | 50 | 50 | 97 | 3 | Random |
| Example 1-2 | | | | | |

### Experimental Example

### Experimental Example 1. Evaluation of Physical Properties of Polyimide Films

### (1) Coefficient of Thermal Expansion (CTE)

With respect to the polyimide films of Examples 1-1 to 1-6 and Comparative Examples 1-1 and 1-2, the slope was measured at 10 °C/min 50 mN in the range of 50 to 200 °C in the machine direction (MD) and transverse direction (TD), respectively, using a TA TMA instrument (Q400). The average coefficient of thermal expansion (CTE_{Ave}) and a difference value (CTE_{MD}−CTE_{TD}) between the coefficient of thermal expansion in a machine direction (MD) (CTE_{MD}) and the coefficient of thermal expansion in a transverse direction (TD) (CTE_{TD}) were then calculated from the above values of the coefficient of thermal expansion in a machine direction (MD) (CTE_{MD}) and the coefficient of thermal expansion in a transverse direction (TD) (CTE_{TD}). The respective measurement results of the coefficient of thermal expansion in a machine direction (MD) (CTE_{MD}), the coefficient of thermal expansion in a transverse direction (TD) (CTE_{TD}), the average coefficient of thermal expansion (CTE_{Ave}), and the difference value (CTE_{MD}−CTE_{TD}) between the coefficient of thermal expansion in a machine direction (MD) (CTE_{MD}) and the coefficient of thermal expansion in a transverse direction (TD) (CTE_{TD}) of the polyimide film are shown in Table 3 below.

### (2) Glass Transition Temperature (Tg)

With respect to the polyimide films of Examples 1-1 to 1-6 and Comparative Examples 1-1 and 1-2, the glass transition temperature was measured using DMA at 10 °C/min. Results thereof are shown in Table 3.

### (3) Modulus

With respect to the polyimide films of Examples 1-1 to 1-6 and Comparative Examples 1-1 and 1-2, samples of 80 mm in length and 15 mm in width were prepared, the modulus of the samples was measured at a rate of 20 mm/min using an Instron 5564 UTM machine from INSTRON, and the average of 10 samples was calculated. Results thereof are shown in Table 3.

### (4) Chemical Resistance

The thickness-based chemical resistance and weight-based chemical resistance were measured with respect to the polyimide films of Examples 1-1 to 1-6 and Comparative Examples 1-1 and 1-2, respectively, and the results are shown in Table 3 below.

The thickness-based chemical resistance above and the weight-based chemical resistance above were measured according to the ASTM D570 absorption rate, respectively. Regarding the impregnation in solution and storage criteria, the chemical resistance was measured by checking the weight and thickness change amounts after impregnation in 15% NaOH solution and storage for 30 minutes under 60 °C conditions.

### (5) Coefficient of Hygroscopic Expansion (CHE)

With respect to the polyimide films of Examples 1-2, 1-3, 1-5, and Comparative Examples 1-1 and 1-2 above, the coefficient of hygroscopic expansion was measured by stabilization at 3 to 90% RH with PMIC equipment until no dimensional change occurred. Results thereof are shown in Table 3.

Table 3 below summarizes the results of the physical property evaluation of the polyimide films of Examples 1-1 to 1-6 and Comparative Examples 1-1 and 1-2.

TABLE 3

| | CTE (ppm/°C) | | | | | | | | |
|---|---|---|---|---|---|---|---|---|---|
| | | | | Difference | | | Chemical | | |
| | | | | value | | | Resistance (%) | | CHE |
| Classi- | | | | (CTE_{MD} − | Tg | Modulus | Thick- | | (ppm/ |
| fication | MD | TD | Ave | CTE_{TD}) | (°C) | (GPa) | ness | Weight | RH %) |
| Exam- | −3.07 | −4.50 | −3.79 | 1.43 | 412 | 12.9 | −14.5 | −13.3 | — |
| ple 1-1 | | | | | | | | | |
| Exam- | −3.19 | −3.55 | −3.37 | 0.36 | 413 | 11.8 | −13.9 | −11.8 | 4.0 |
| ple 1-2 | | | | | | | | | |
| Exam- | −1.55 | −1.78 | −1.67 | 0.23 | 406 | 10.3 | −16.2 | −13.9 | 4.4 |
| ple 1-3 | | | | | | | | | |
| Exam- | −3.03 | −2.40 | −2.72 | −0.63 | 409 | 12.6 | −14.4 | −14.4 | — |
| ple 1-4 | | | | | | | | | |
| Exam- | −0.30 | −0.73 | −0.5 | 0.43 | 402 | 9.8 | −18.9 | −20.1 | 5.7 |
| ple 1-5 | | | | | | | | | |
| Exam- | 3.8 | 2.0 | 2.9 | 1.8 | 402 | 8.1 | −25.0 | −24.6 | — |
| ple 1-6 | | | | | | | | | |
| Compar- | 9.4 | 4.8 | 7.1 | 4.6 | 400 | 6.2 | −32.1 | −34.2 | 7.2 |
| ative | | | | | | | | | |
| Exam- | | | | | | | | | |
| ple 1-1 | | | | | | | | | |
| Compar- | 3.1 | 3.4 | 3.2 | −0.3 | 400 | 8.8 | −34.0 | −32.9 | 6.7 |
| ative | | | | | | | | | |
| Exam- | | | | | | | | | |
| ple 1-2 | | | | | | | | | |

It could be confirmed from Table 3 that when including a block copolymer, as compared to Comparative Example 1-1 having an m-TD amount of 30 mol %, Examples having an m-TD amount of 40 to 80 mol % had superior chemical resistance and also showed better CTE and CHE.

In addition, when comparing the physical properties depending on whether or not blocks are included in the same amount of m-TD (Example 1-5 and Comparative Example 1-2), it could be appreciated that the other physical properties were similar, but the heat resistance and chemical resistance were significantly superior when including the blocks.

From these results, it can be seen that the polyamic acid of the present disclosure and the polyimide film prepared therefrom have excellent heat resistance, chemical resistance, moisture resistance, and mechanical properties without the use of p-phenylenediamine (PPD).

Further, the polyimide film according to the present disclosure does not use p-phenylenediamine (PPD), and thus has the effect of being relatively cost-competitive and having excellent productivity and process efficiency.

In the present specification, the detailed description of the contents capable of being sufficiently recognized and inferred by those skilled in the art of the present disclosure are omitted, and many variations and modifications can be made within a range that does not change the technical spirit or essential configuration of the present disclosure in addition to the specific exemplary embodiments described in the present specification. Therefore, the present disclosure may also be practiced in a manner different from that specifically described and illustrated herein, which can be understood by those skilled in the art.

1. A polyimide film comprising:
a copolymer in which a dianhydride monomer including pyromellitic dianhydride (PMDA) is copolymerized with a diamine monomer including 4,4′-diaminodiphenyl ether (ODA) and m-tolidine (m-TD),
wherein the film has a coefficient of thermal expansion in a transverse direction (TD) (CTE_{TD}) of −5 to 2.5 ppm/°C measured at a temperature range of 50 to 200 °C and a heating rate of 10 °C/min, and
a modulus of 8 GPa or more.

2. The polyimide film of claim 1, wherein in the polyimide film, a difference value (CTE_{MD}−CTE_{TD}) between a coefficient of thermal expansion in a machine direction (MD) (CTE_{MD}) and the coefficient of thermal expansion in a transverse direction (TD) (CTE_{TD}) is-3 to 3 ppm/°C.

3. The polyimide film of claim 1, wherein an average coefficient of thermal expansion (CTE_{Ave}) of the polyimide film is-4.25 to 3.0 ppm/° °C, and
the average coefficient of thermal expansion (CTE_{Ave}) is an average value of a coefficient of thermal expansion in a machine direction (MD) (CTE_{MD}) and the coefficient of thermal expansion in a transverse direction (TD) (CTE_{TD}) Of the polyimide film.

4. The polyimide film of claim 1, wherein the copolymer is a block copolymer having two or more blocks.

5. The polyimide film of claim 4, wherein the block copolymer comprises a first block in which a dianhydride monomer including pyromellitic dianhydride (PMDA) is copolymerized with a diamine monomer including m-tolidine (m-TD); and
a second block in which a dianhydride monomer including pyromellitic dianhydride (PMDA) is copolymerized with a diamine monomer including 4,4′-diaminodiphenyl ether (ODA).

6. The polyimide film of claim 1, wherein an amount of the m-tolidine (m-TD) in the total diamine monomers of the copolymer is 40 to 80 mol %.

7. The polyimide film of claim 1, wherein an amount of the 4,4′-diaminodiphenyl ether (ODA) in the total diamine monomers of the copolymer is 20 to 60 mol %.

8. The polyimide film of claim 1, wherein the polyimide film has a glass transition temperature (Tg) of 380 °C or higher.

9. The polyimide film of claim 1, wherein the polyimide film has a thickness-based chemical resistance of −25 to −13%, and a weight-based chemical resistance of −25 to −10%.

10. The polyimide film of claim 1, wherein a coefficient of hygroscopic expansion of the polyimide film is 3 to 6 ppm/RH %.

11. The polyimide film of claim 1, wherein a thickness of the polyimide film is 1 to 100 μm.

12. A method for preparing a polyimide film, comprising: copolymerizing a dianhydride monomer including pyromellitic dianhydride (PMDA) with a diamine monomer including 4,4′-diaminodiphenyl ether (ODA) and m-tolidine (m-TD),
wherein the polyimide film has a coefficient of thermal expansion in a transverse direction (TD) (CTE_{TD}) of −5 to 2.5 ppm/° °C measured at a temperature range of 50 to 200 °C and a heating rate of 10 °C/min, and
a modulus of the polyimide film is 8 GPa or more.

13. The method of claim 12, wherein the copolymerizing comprises:
preparing a first block by copolymerizing a dianhydride monomer including pyromellitic dianhydride (PMDA) with a diamine monomer including m-tolidine (m-TD); and
preparing a second block by copolymerizing a dianhydride monomer including pyromellitic dianhydride (PMDA) with a diamine monomer including 4,4′-diaminodiphenyl ether (ODA).

14. The method of claim 13, wherein in the preparing the first block,
an amount of the diamine monomer including the m-tolidine (m-TD) is 40 to 80 mol %,
an amount of the dianhydride monomer including the pyromellitic dianhydride (PMDA) is 20 to 70 mol %, and
a ratio (M_{m-TD}/M_{1st PMDA}) of the amount of the diamine monomer including the m-tolidine (m-TD) (M_{m-TD}) to the amount of dianhydride monomer including the pyromellitic dianhydride (PMDA) (M_{1st PMDA}) is more than 1 and less than 2.

15. The method of claim 13, wherein in the preparing the second block,
an amount of the diamine monomer including the 4,4′-diaminodiphenyl ether (ODA) is 20 to 60 mol %,
an amount of the dianhydride monomer including the pyromellitic dianhydride (PMDA) is 30 to 80 mol %, and
a ratio (M_{ODA}/M_{2nd PMDA}) of the amount of the diamine monomer including the 4,4′-diaminodiphenyl ether (ODA) (M_{ODA}) to the amount of the dianhydride monomer including the pyromellitic dianhydride (PMDA) (M_{2nd PMDA}) is more than 0 and less than 1.
